(19) United States
(12) Patent Application Publication
(10) Pub. No.: US 2019/0164105 A1
(43) Pub. Date: May 30, 2019

(54) METHOD AND SYSTEM FOR QUALITY CONTROL OF A FACILITY BASED ON INTERNET OF THINGS

(71) Applicant: Ruptub Solutions Private Limited, Karnataka (IN)

(72) Inventors: Sidharth Gupta, Bangalore (IN); Kadam Jeet Jain, Bangalore (IN); Rahul Chaudhary, Bangalore (IN); Punit Garg, Bangalore (IN); Khilan Haria, Bangalore (IN); Ankita Gandhi, Agra (IN); Vidit Sinha, Bangalore (IN); Rajdeep Singh, Karnataka (IN); Abhishek Nair, Mumbai (IN); Shashank Rao, Bangalore (IN); Shubhangi Agarwal, Lucknow (IN); Abhishek Malani, Hyderabad (IN); Raghavendra Reddy, ANDHRA PRADESH (IN); Ribin Paikattu Kavil, Bangalore (IN); Rahul Boggaram Nagarjuna Gupta, Bangalore (IN)

(21) Appl. No.: 15/897,546

(22) Filed: Feb. 15, 2018

(30) Foreign Application Priority Data
Nov. 25, 2017 (IN) 201741042321

(51) Int. Cl. G06Q 10/06; G06Q 10/00; H04L 29/08

(52) U.S. Cl. CPC G06Q 10/06395; H04L 67/12; G06Q 10/20

(57) ABSTRACT

A method and system for quality control of a facility based on Internet of things. The system obtains data of the facility from plurality of architectural sources. The system creates a digital replica of the facility and defines plurality of control point levels for each region of the plurality of regions. The system allocates plurality of smart devices based on plurality of micro-descriptors. The system collects data associated with the facility and deciphers the data into one or more matrix. The system analyzes data with the pre-defined standard quality matrix in real time. The system assigns a degree of severity of the identified one or more issues. The system apprises one or more workforces associated with the facility to resolve the one or more issues including high degree of severity and the plurality of smart devices to take action to resolve the one or more issues.

### CROSS-REFERENCES TO RELATED APPLICATION

The present application claims the benefit under 35 U.S.C. § 119(e) of the filing date of India Patent Application Serial No. 201741042321 for SYSTEM FOR QUALITY CONTROL OF A FACILITY BASED ON INTERNET OF THINGS, filed Nov. 25, 2017, which is hereby incorporated by reference in its entirety for all purposes.

### TECHNICAL FIELD

The present disclosure relates to a field of quality control. More specifically, the present disclosure relates to a system for quality control of a facility based on Internet of things.

### BACKGROUND

Service industry has taken a major leap with the huge increase in number of people constantly travelling from one place to another. People are in constant need for a place to stay overnight or for a few days. Typically, people stay in various hotels which match their needs and comfort ability factor. These hotels have been operating in an automated fashion since very long. Nowadays, there are innumerable software systems for managing hotel operations in real time. Further, these hotels continuously try to evolve and understand their customer needs in order to be more efficient. Maintenance of quality of the hotels is a big task for hotel owners. In addition, managing the quality of the facility needs time and money. Managing quality of the facility includes a regular audit of the facility, solving multiple major issues related to the facility and monitoring a large number of tasks related to the audit. Maintaining the quality of a facility requires one or more devices in order to collect information and perform certain number of tasks. The devices use wired connection in order to keep them connected to the main server and perform its task. Using the wired connection has a downside as a single loose wire will affect the performance of the system and the devices does not provide information in real time to keep track on the quality of the facility. As an example, the feedback provided by the customer is used to make changes which are applied after the visitor has left the facility which decrease the quality of service of the facility. Therefore, the wired connections do not provide efficient way of communicating information from devices and are not reliable. Further, information collected is stored separately for each device and does not prove to be useful for keeping track on the overall quality of the facility. In order to check all the aspects of the quality by using all the devices working together with each other, there is a need for a new system which overcomes the above-stated disadvantages.

### SUMMARY

In a first example, a computer-implemented method is provided. The computer-implemented method may be configured to perform quality control of a digital facility based on internet of things. The computer-implemented method may include a first step of obtaining a first set of data associated with each region of a plurality of regions of the digital facility. In addition, the computer-implemented method may include a second step of creating one or more digital replica of the digital facility for each region of the plurality of regions of the digital facility. Further, the computer-implemented method may include a third step of defining each region of the plurality of regions of the digital facility into a plurality of control point levels. Furthermore, the computer-implemented method may include a fourth step allocating a plurality of smart devices for the digital facility based on a plurality of micro-descriptors. Moreover, the computer-implemented method may include a fifth step of collecting a second set of data associated with the digital facility. Also, the computer-implemented method may include a sixth step of deciphering the second set of data into one or more matrix. Also, the computer-implemented method may include a seventh step of analyzing the second set of data with the pre-defined standard quality matrix in real time. Also, the computer-implemented method may include an eighth step of assigning a degree of severity to the identified one or more issues. Also, the computer-implemented method may include a ninth step of apprising the one or more workforces associated with the digital facility to resolve the one or more issues comprising the high degree of severity and the plurality of smart devices to take action in order to resolve the one or more issues. The first set of data may be obtained from a plurality of architectural sources in real time. The one or more digital replica may be created with the facilitation of the first set of data. The plurality of control point levels may be classified based on a pre-defined set of data associated with the one or more digital replica. The plurality of micro-descriptors may be described for lowest level of the plurality of control point levels. The plurality of smart devices may be internet of things enabled devices. The second set of data may be collected from the plurality of smart devices in real time. The deciphering may be done to align the second set of data into structured information. The deciphering may be done in real time. The analyzing may be done to identify the one or more issues associated with the digital facility. The degree of severity may be assigned to recognize the one or more issues comprising a high degree of severity.

In an embodiment of the present disclosure, the plurality of architectural sources include image capturing devices, a digital blueprint, a portable communication device and one or more geographical sensors.

In an embodiment of the present disclosure, the plurality of smart devices include plurality of sensor, actuator and one or more portable communication devices. The plurality of smart devices is connected to each other through internet.

In an embodiment of the present disclosure, the one or more matrix includes a facility specific matrix and a workforce specific matrix. The one or more matrix is deciphered in real time.

In an embodiment of the present disclosure, the one or more issues include a broken door, faucet flow, defected bulb, defected fire alarm, low intensity of bulb, unclean floor, high volume of noise, putrid odor, broken cabinet, blocked shower and Wi-Fi connection.

In an embodiment of the present disclosure, the computer-implemented method may perform yet another step of updating the first set of data, the second set of data, the one or more issues and the degree of severity. The updating is done in real time.

In an embodiment of the present disclosure, the computer-implemented method may perform yet another step of storing the first set of data, the second set of data, the one or more issues and the degree of severity. The storing is done in real time.

In an embodiment of the present disclosure, the computer-implemented method may perform yet another step of ceasing booking of each region of the plurality of regions of the digital facility. The ceasing is done based on the high degree of severity and accordance ratio of the digital facility. The ceasing is done in real time.

In an embodiment of the present disclosure, the computer-implemented method may perform yet another step of forecasting the one or more issues and estimated time to resolve the one or more issues in order to maintain the quality of the digital facility. The forecasting is done by analyzing the already stored data and time-series data in real time.

In an embodiment of the present disclosure, the computer-implemented method may perform yet another step of awarding incentives to the one or more workforces associated with the digital facility based on a plurality of factors.

In a second example, a computer system is provided. The computer system may include one or more processors and a memory coupled to the one or more processors. The memory may store instructions which, when executed by the one or more processors, may cause the one or more processors to perform a method. The method is configured to perform quality control of a digital facility based on internet of things. The method may include a first step of obtaining a first set of data associated with each region of a plurality of regions of the digital facility. In addition, the method may include a second step of creating one or more digital replica of the digital facility for each region of the plurality of regions of the digital facility. Further, the method may include a third step of defining each region of the plurality of regions of the digital facility into a plurality of control point levels. Furthermore, the method may include a fourth step allocating a plurality of smart devices for the digital facility based on a plurality of micro-descriptors. Moreover, the method may include a fifth step of collecting a second set of data associated with the digital facility. Also, the method may include a sixth step of deciphering the second set of data into one or more matrix. Also, the method may include a seventh step of analyzing the second set of data with the pre-defined standard quality matrix in real time. Also, the method may include an eighth step of assigning a degree of severity to the identified one or more issues. Also, the method may include a ninth step of apprising the one or more workforces associated with the digital facility to resolve the one or more issues comprising the high degree of severity and the plurality of smart devices to take action in order to resolve the one or more issues. The first set of data may be obtained from a plurality of architectural sources in real time. The one or more digital replica may be created with the facilitation of the first set of data. The plurality of control point levels may be classified based on a pre-defined set of data associated with the one or more digital replica. The plurality of micro-descriptors may be described for lowest level of the plurality of control point levels. The plurality of smart devices may be internet of things enabled devices. The second set of data may be collected from the plurality of smart devices in real time. The deciphering may be done to align the second set of data into structured information. The deciphering may be done in real time. The analyzing may be done to identify the one or more issues associated with the digital facility. The degree of severity may be assigned to recognize the one or more issues comprising a high degree of severity.

In a third example, a computer-readable storage medium is provided. The computer-readable storage medium encodes computer executable instructions that, when executed by at least one processor, performs a method. The method is configured to perform quality control of a digital facility based on internet of things. The method may include a first step of obtaining a first set of data associated with each region of a plurality of regions of the digital facility. In addition, the method may include a second step of creating one or more digital replica of the digital facility for each region of the plurality of regions of the digital facility. Further, the method may include a third step of defining each region of the plurality of regions of the digital facility into a plurality of control point levels. Furthermore, the method may include a fourth step allocating a plurality of smart devices for the digital facility based on a plurality of micro-descriptors. Moreover, the method may include a fifth step of collecting a second set of data associated with the digital facility. Also, the method may include a sixth step of deciphering the second set of data into one or more matrix. Also, the method may include a seventh step of analyzing the second set of data with the pre-defined standard quality matrix in real time. Also, the method may include an eighth step of assigning a degree of severity to the identified one or more issues. Also, the method may include a ninth step of apprising the one or more workforces associated with the digital facility to resolve the one or more issues comprising the high degree of severity and the plurality of smart devices to take action in order to resolve the one or more issues. The first set of data may be obtained from a plurality of architectural sources in real time. The one or more digital replica may be created with the facilitation of the first set of data. The plurality of control point levels may be classified based on a pre-defined set of data associated with the one or more digital replica. The plurality of micro-descriptors may be described for lowest level of the plurality of control point levels. The plurality of smart devices may be internet of things enabled devices. The second set of data may be collected from the plurality of smart devices in real time. The deciphering may be done to align the second set of data into structured information. The deciphering may be done in real time. The analyzing may be done to identify the one or more issues associated with the digital facility. The degree of severity may be assigned to recognize the one or more issues comprising a high degree of severity.

### BRIEF DESCRIPTION OF FIGURES

Having thus described the aspects of the disclosed embodiments in general terms, reference will now be made to the accompanying drawings, which are not necessarily drawn to scale, and wherein:

FIG. 1 illustrates an example of a plurality of regions of a digital facility, in accordance with an embodiment of the present disclosure;

FIG. 2 illustrates an interactive computing environment for analyzing data collected from plurality of sources in order to maintain quality of the digital facility based on Internet of things, in accordance with various embodiments of the present disclosure;

FIG. 3A and FIG. 3B illustrate a flowchart for a method for quality control of the digital facility based on the internet of things, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

Reference will now be made in detail to selected embodiments of the present disclosure in conjunction with accompanying figures. The embodiments described herein are not intended to limit the scope of the present disclosure, and the present disclosure should not be construed as limited to the embodiments described. This present disclosure may be embodied in different forms without departing from the scope and spirit of the disclosed embodiments. It should be understood that the accompanying figures are intended and provided to illustrate embodiments of the present disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

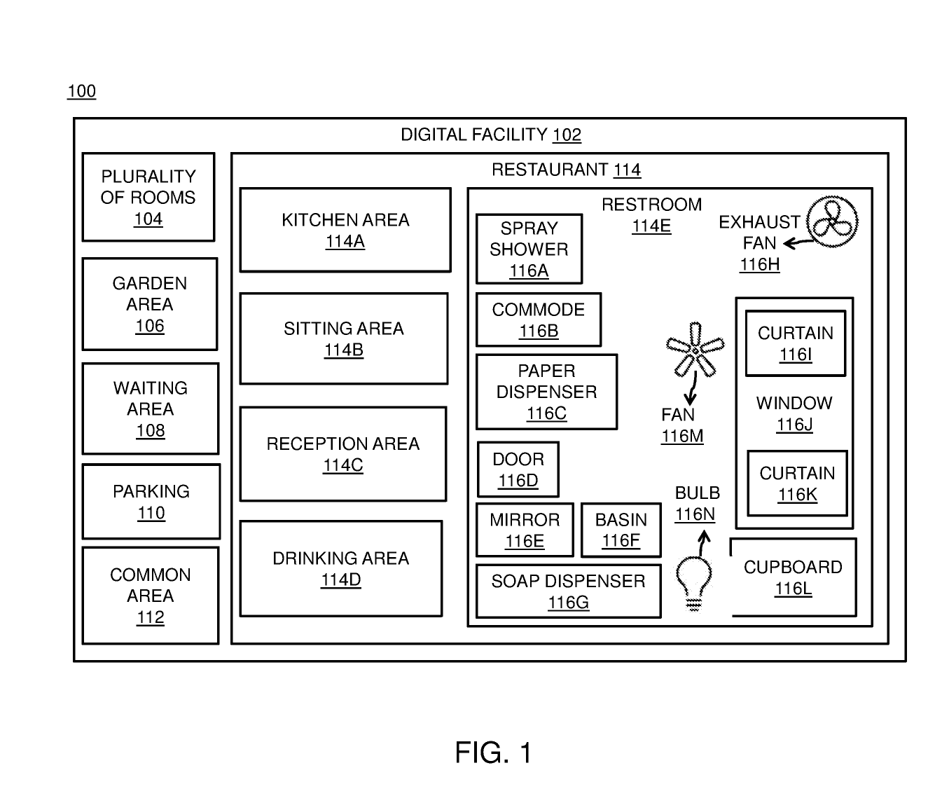

FIG. 1 illustrates a block diagram 100 of a digital facility 102, in accordance with various embodiments of the present disclosure. The digital facility 102 is a place where people live or stay for a period of time. The digital facility 102 may be a hotel which provides accommodation, meals, and hospitality services for the visitors on a short-term basis and provides space for conducting conference, meetings, social gathering, family function, events, and the like. In an embodiment of the present disclosure, the digital facility 102 may be a hospital which provides health care services to the people. In another embodiment of the present disclosure, the digital facility 102 may be a house or a school. In another embodiment of the present disclosure, the digital facility 102 may be the guest house which provides accommodation facility to the guest or visitor. In yet another embodiment of the present disclosure, the digital facility 102 may be a military base which is operated by or for the military. In yet another embodiment of the present disclosure, the digital facility 102 may be an old age home or place of work. In yet another embodiment of the present disclosure, the digital facility 102 may be a lodge, boarding house or a supermarket. In yet another embodiment of the present disclosure, the digital facility 102 includes but may not be limited to production area of a factory or an industry. In yet another embodiment of the present disclosure, the digital facility 102 includes but may not be limited to a mall, railway station, bus station and the like. The digital facility 102 includes a plurality of regions which are used to specify the area of the digital facility 102 in order to identify the regions for quality control.

In an embodiment of the present disclosure, the digital facility 102 includes the plurality of regions. The plurality of regions includes but is not be limited to a plurality of rooms 104, garden area 106, waiting area 108, parking area 110, common area 112, restaurant 114, kitchen, garden, reception area and corridor, stairs. In another embodiment of the present disclosure, the plurality of regions includes but is not be limited to shopping area, cash counter, baggage counter, ticket counter, help desk, waiting area, toilets and conference area. In yet another embodiment of the present disclosure, the plurality of regions includes but is not be limited to the meeting area, event area, the ground area, task area, gym area, swimming area, classroom area and canteen area. The plurality of rooms 104 is an area inside the digital facility 102 where people live, spend time and perform various activities. In an embodiment of the present disclosure, the plurality of rooms 104 includes but is not be limited to a hotel room, kids room, living room, meeting room, dining room, staff room, classroom, activity room, changing room and store room. The plurality of regions is further broken down into each region of the plurality of regions to specify the components of the plurality of regions. In an example, as illustrated in FIG. 1, the plurality of regions of the digital facility 102 consists of the plurality of rooms 104, the garden area 106, the waiting area 108, parking area 110, the common area 112 and the restaurant 114.

Each region of the plurality of regions is used to specify a particular area of a plurality of areas of the digital facility 102. Each region specifies area where a check on the quality should be maintained in the digital facility 102. Each region includes the bed area, table area, chair area, bulb area, curtain area, window area, almirah area, working area, fan area and the like. In an embodiment of the present disclosure each region of the plurality of regions includes but may not be limited to the stage area, car parking area, bus parking area, ammunition area, tent area, shower area, towel area, soap area and carpet area. In another embodiment of the present disclosure, each region of the plurality of regions includes but may not be limited to instrument area, book area, locker area, A.C area, pool area and spa area. Each region of the plurality of regions is further classified into a plurality of quality points. In an example, as illustrated in FIG. 1, each region of the plurality of regions of the digital facility 102 has been specified for the restaurant 114 of the digital facility 102. Each region of the plurality of regions of the restaurant 114 consists of kitchen area 114a, sitting area 114b, reception area 114c, drinking area 114d, and restroom area 114e. Each of the specified area defines each region of the plurality of regions.

The plurality of quality points is used to specify the particular points of each region of the plurality of regions of the digital facility 102. Each of the plurality of quality points specifies the area where a check on quality should be maintained in the digital facility 102. The plurality of quality points includes but may not be limited to spray shower 116a, commode 116b, paper dispenser 116c, door 116d, mirror 116e, basin 116f, soap dispenser 116g, exhaust fan 116h, curtain 116i, window 116j. The plurality of quality points includes but may not be limited to cupboard 116l, fan 116m, television light and bulb 116n. In an embodiment of the present disclosure, the plurality of quality points includes but may not be limited to bed crack, mattress, linen-condition, pillow cover, blanket sturdiness, bulb light, adaptor, television wire and curtain rod. In another embodiment of the present disclosure, the plurality of quality points includes but may not be limited to the door, water cooler, box, chair cover, carpet, mirror, bathroom cabinet, laptop stand and iron stand. In yet another embodiment of the present disclosure, the plurality of quality points includes but may not be limited to curtain, cupboard cover, cupboard lock, fan stand, fan, air conditioner, heater, table cover and chair cover. In yet another embodiment of the present disclosure, the plurality of quality points includes soap dispenser, coffee machine, sturdiness, cleanliness, linen condition, shower, air freshener, exhaust, faucets, toilet paper, flush and the like. In yet another embodiment of the present disclosure, the plurality of quality points includes welcome drink, elevator, emergency light, fragrance, elevator, shafts, Wi-Fi signal, staff dress, wall, noise, upholstery and the like.

In an example, as illustrated in FIG. 1, quality points of the restroom area 114e are specified to showcase the plurality of quality points that is used for quality control for each region of the plurality of regions of the digital facility 102. The plurality of quality points of the restroom area 114e is spray shower 116a, commode 116b, paper dispenser 116c, door 116d, mirror 116e, basin 116f, soap dispenser 116g, exhaust fan 116h. Further, the plurality of quality points of the restroom area 114e is curtain 116i, window 116j, second curtain 116k, cupboard 116l, fan 116m, and bulb 116n.

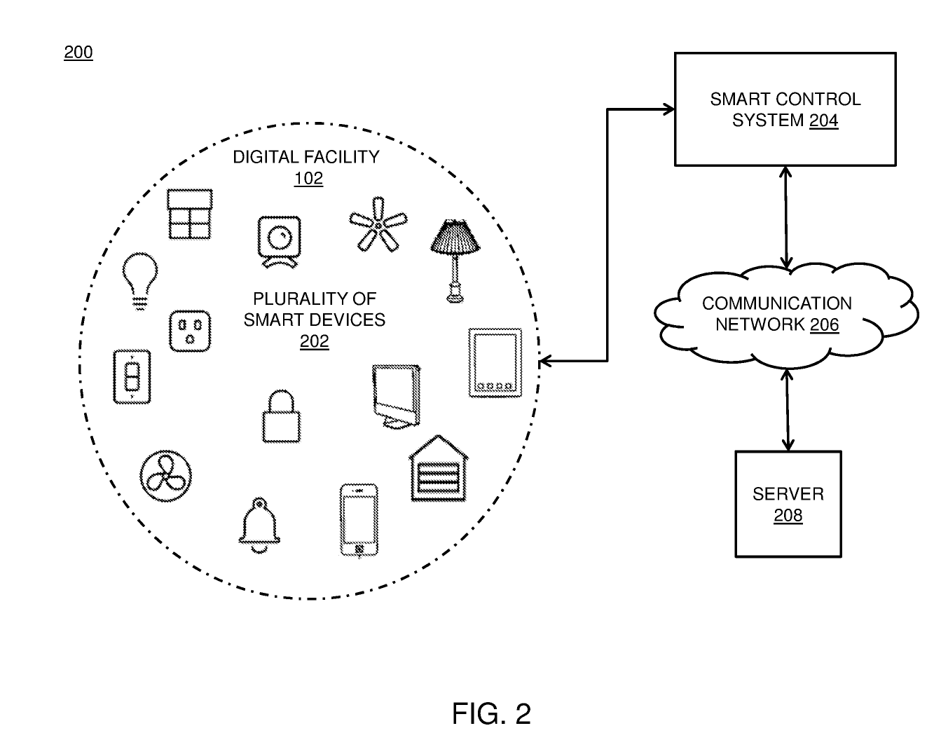

FIG. 2 illustrates a block diagram 200 of an interactive computing environment for analyzing data collected from the plurality of sources in order to maintain quality of the digital facility 102, in accordance with various embodiments of the present disclosure. The interactive computing environment is based on the internet of things. The interactive computing environment includes the digital facility 102 a plurality of smart devices 202, a smart control system 204, a communication network 206 and a server 208. The plurality of smart devices 202 is electronic devices which are connected to each other via a wireless technology and may be operated from a remote location. The plurality of smart devices 202 is used to collect and receive information from other devices connected in the network and act autonomously on the collected data based on the analysis. The plurality of smart devices 202 is connected by the wireless technology which uses internet, radio waves to transmit information without cables or wiring. The plurality of smart devices includes a plurality of sensor, actuator, and one or more portable communication devices and the like. In an embodiment of the present disclosure, the plurality of smart devices includes smartphones, tablets , smartwatches, smart bands, smart key chains and the like. The wireless technology used to connect plurality of smart to each other for each region of plurality of regions of the digital facility 102 is internet which creates a network of connected devices called “Internet of things”. In an embodiment of the present disclosure, the wireless technology includes Bluetooth, Wi-Fi, 3G, 4G, internet, near-field communication and the like. The wireless technology helps to increase mobility and reduces cost of infrastructure. The plurality of smart devices is installed in the digital facility 102 by one or more workforces associated with the digital facility 102. The plurality of smart devices is installed by the one or more workforces associated with the digital facility 102.

In an embodiment of the present disclosure, the Internet of things is the network of the plurality of smart devices 202 connected via internet to enable collection and exchange data. In general, the Internet of things is the network of physical devices, vehicles, and other items embedded with electronics, software, sensors, actuators, and network connectivity which enable these objects to collect and exchange data. The Internet of things is the network of the plurality of smart devices 202 which exchange data from each other in the environment for the characteristic parameter. The Internet of things collects data and take action based on the analysis based on the collected data perform analysis to take action. In an example, as illustrated in FIG. 2, the digital facility 102 includes the plurality of smart devices 202 located at each region of the plurality of regions of the digital facility 102. The plurality of smart devices 202 is connected with each other through internet which enables them to collect and exchange data. The network of the plurality of smart devices 202 connected with each other through internet in the digital facility 102 creates the environment of the Internet of things.

The one or more workforces associated with the digital facility 102 are the staff involved in maintaining the quality off the digital facility 102. The one or more workforces include but is not limited to one or more staff, one or more quality examiners, and one or more mystery auditors. The one or more staff includes but may not be limited to housekeeping staff, kitchen staff, reception staff, serving staff, and security staff.

In an embodiment of the present disclosure, the one or more quality examiners are persons who keep a check on the quality of the digital facility 102. The one or more quality examiners include a member of the digital facility 102 who is not associated as one or more staff of the digital facility, any person from the franchisor in case of the franchised digital facility and the like. The one or more quality examiners are assigned a task to audit each region of the plurality of regions of the digital facility 102 where there is issue or issue may be raised in the near future. The one or more quality examiners are assigned a task based on demographic information of the one or more quality examiners which is stored in the smart control system 204. The one or more quality examiners are notified by a notification on a portable communication device based on his demographic information and the task which he needs to perform in order to maintain the quality of the digital facility 102. The one or more quality examiners are to audit each region of the plurality of regions which are specified in the task and report the condition of one or more issues.

In an embodiment of the present disclosure, the demographic information includes data related to the one or more workforces comprises of name, age, city, contact details, permanent address and the like. In another embodiment of the present disclosure, the demographic information includes alternative address, qualification, date of joining of the digital facility and the like. The demographic information includes but may not be limited to gender, profession and name of the digital facility 102 assigned to the one or more quality examiner in case of data related to one or more quality examiners.

In an example, if the quality examiner X is having plumbing as his profession in the demographic information stored in the quality smart system and there is need to check quality of plumbing in the digital facility D. The quality examiner X is assigned the task of auditing the plumbing of the digital facility D as the digital facility D is mentioned in the demographic information of the quality examiner X.

In an embodiment of the present disclosure, the one or more issues are problems which affect the quality of the digital facility 102. In an embodiment of the present disclosure, the one or more issues are fault in electrical appliance, unprofessional manpower, unprofessional quality manager, hygiene and the like. In an embodiment of the present disclosure, the one or more issues includes cleanliness, security, limited amenities at the digital facility, wireless connectivity issues, noise, pollution and the like. In an embodiment of the present disclosure, the one or more issues includes lack of manpower at the digital facility 102, sturdiness, cleanliness, linen condition, toilet paper, and the like. In an embodiment of the present disclosure, the one or more issues includes shower pressure, air freshener, exhaust, faucets, CCTV working, walls, ambiance, buffet counter, CCTV video quality and the like. In an embodiment of the present disclosure, the one or more issues includes hygiene, table dust, staff behavior, kettle, window pane, T.V wire, light switch, feedback tab, fire safety, smoke alarm, and the like.

In an embodiment of the present disclosure, the one or more mystery auditors are persons who are assigned the task of secretly conducting the quality check of the digital facility 102. The one or more mystery auditors include any person who is not the member of the digital facility 102, a visitor of the digital facility 102 and the like. A notification is sent based on the location of the digital facility 102 to the one or more mystery auditors nearby the digital facility for audit. One of the mystery auditor from the one or more mystery auditors accepts the request for auditing and he is assigned a checklist which he needs to check in order inspect the quality of the digital facility 102. One of the mystery auditors provides his personal feedback regarding the changes that need to be made in order to enhance the quality of the digital facility 102. In another embodiment of the present disclosure, the one or more mystery auditors can select the hotel of his choice for audit based on his preferred location in order to inspect the quality of the digital facility 102. The one or more mystery auditors selects a city of his choice and enter the date of his stay based on which a list of the digital facility 102 is shown to the one or more mystery auditors. The one or more mystery auditors selects the digital facility 102 from the list of the digital facility 102 to book a room from the plurality of rooms 104 of the digital facility 102 based on the availability of the room from the plurality of the rooms. After the stay at the digital facility the one or more mystery auditors provides his feedback on the quality of the digital facility 102.

In another embodiment of the present disclosure, the plurality of sensor is used to collect information from the plurality of smart devices. The plurality of sensor is Internet of things enabled and embedded sensors. The plurality of sensor includes but may not be limited to temperatures sensor, pressure sensor, biosensor, an image sensor, motion sensor, level sensor, humidity sensor, tilt sensor, light sensor. In addition, the plurality of sensor includes but may not be limited to defect detector, speed flow sensor, fire sensor, smoke sensor, air sensor, position sensor, alarm sensor, odometer, pyrometer, an infrared sensor, stretch sensor. Further, the plurality of sensor includes illumination sensor, depth detector, noise detector, and the like.

In another embodiment of the present disclosure, the one or more portable communication devices are device which helps to communicate information. The one or more portable communication devices are Internet of things enabled devices. The one or more portable communication devices includes but may not be limited to a smartphone, a laptop, a desktop computer, a tablet, and a personal digital assistant. In another embodiment of the present disclosure, the recording facility is enabled through one or more microphones installed in the one or more portable communication devices. In another embodiment of the present disclosure, the image capturing facility is enabled through one or more camera installed in the one or more portable communication devices. In an embodiment of the present disclosure, the one or more portable communication devices are currently in the switched-on state.

The interactive computing environment includes the smart control system 204 which performs the task of maintaining quality of the digital facility in real time based on the Internet of things. The smart control system 204 keeps check on the quality by performing sequence of tasks which includes but may not be limited to collect data from the plurality of smart devices 202, analyze the collected data, identify the one or more issues, predict the one or more issues, and act on the one or more issues.

The smart control system 204 receives a first set of data in real time. The first set of data is associated with each region of the plurality of regions of the digital facility 102. The first set of data is received from a plurality of architectural sources. In an embodiment of the present disclosure, the first set of data includes but may not be limited to the architectural information, interior information of the digital facility 102, images of the digital facility 102, and 360-degree view of the digital facility 102. In an embodiment of the present disclosure, the architectural information includes but may not be limited to building architecture, outside view of the digital facility, inside view of the digital facility 102. In another embodiment of the present disclosure, architectural information includes but may not be limited to number of floors of the digital facility 102, garden architectural information, parking architectural information, gym architectural information. In another embodiment of the present disclosure, architectural information includes club architectural information, pool area, spa area, drinking area, concert area and the like.

In an embodiment of the present disclosure, the interior information includes but may not be limited to room interior information, restaurant interior information, toilets interior information, library interior information. In another embodiment of the present disclosure, the interior information includes but may not be limited to spa interior information, office interior information, meeting room interior information.

In an example, the first set of data includes building architecture, outside view of the digital facility, inside view of the digital facility, number of floors, placement of windows, placement of reception and the like.

In an embodiment of the present disclosure, the plurality of architectural sources is used to collect information of the digital facility 102. The plurality of architectural sources includes an image capturing device, a digital blueprint, a portable communication device, and one or more geographical sensors. In another embodiment of the present disclosure, the plurality of architectural sources 202 includes but may not be limited to Google map, 3D camera, biosensors, and building information models. In an embodiment of the present disclosure, the plurality of architectural sources is provided by a visitor, facility staff, architectural view of the facility and the like. In yet another embodiment of the present disclosure, the plurality of architectural sources is provided by the facility manager on the one or more portable communication devices.

In addition, the smart control system 204 creates one or more digital replica for each region of the plurality of regions of the digital facility 102 by using the first set of data in real time. In general, the digital replica is a reproduction or copy of the original, concerning original shape and appearance. In an embodiment of the present disclosure, the one or more digital replica includes but may not be limited to a 3D view, 3D animation, architectural visualization, and the like.

Further, the smart control system 204 defines each region of the plurality of regions of the digital facility 102 into a plurality of control point levels. The plurality of control point levels is used to simplify the distribution of each area of the plurality of areas of the digital facility 102. The plurality of control point levels is used to simplify the user interface on the one or more portable communication devices and provide ease of use. The plurality of control point levels is defined from outside to the inside of each area of the plurality of areas of the digital facility 102 such that each level holds a plurality of control point. The lowest level of the plurality of control point levels holds the plurality of control point which defines the key areas of the plurality of areas of the digital facility 102 to be considered for maintaining the quality of the digital facility 102. The lowest level of the plurality of control point levels is used to specify the control point very an issue may be present or one which is essential for maintaining the quality of the digital facility 102. The plurality of control point specified at the lowest level of the plurality of control point levels is used to define the issue and estimated time to resolve a particular issue. The plurality of control point levels is classified based on a pre-defined set of data.

The pre-defined set of data is the key area for each area of the plurality of areas of the digital facility 102 considered for maintaining the quality. The predefined set of data is provided by the digital facility 102 owner, visitor, one or more quality examiner, franchiser in case of a franchise, and the like which can be updated any time. In an embodiment of the present disclosure, the pre-defined set of data includes but may not be limited to bed crack, linen condition, mattress, bedsheet stain, pillow cover, blanket sturdiness, bulb light, television light, and adaptor. In another embodiment of the present disclosure, the pre-defined set of data includes but may not be limited to television wire, curtain rod, curtain, cupboard cover, cupboard lock, fan stand, fan, air conditioner. In yet another embodiment of the present disclosure, the pre-defined set of data includes but may not be limited to table cover, chair cover, door, water cooler, heater, chair cover, carpet, mirror, and bathroom cabinet. In yet another embodiment of the present disclosure, the pre-defined set of data includes soap dispenser, coffee machine, sturdiness, cleanliness, linen condition, shower pressure, and the like. In yet another embodiment of the present disclosure, the pre-defined set of data includes but may not be limited to air freshener, exhaust, faucets, toilet paper, flush, wall, noise, upholstery. In yet another embodiment of the present disclosure, the pre-defined set of data includes but may not be limited to welcome drink, elevator, emergency light, fragrance, elevator, shafts, and Wi-Fi signal. In yet another embodiment of the present disclosure, the pre-defined set of data includes staff behavior, kettle, window pane, TV wire, light switch, feedback tab, public washroom, and the like. In yet another embodiment of the present disclosure, the pre-defined set of data includes buffet counter, hygiene, staff grooming, CCTV video quality, mop, dusting, vacuum cleaning, fire safety, smoke alarm, and the like.

In an example, the digital facility 102 is a hotel X consisting of the plurality of rooms 104, garden area 106, waiting area 108, parking area 110, common area 112, and restaurant 114. The first set of data is received by the smart control system 204 which creates the one or more digital replica of the digital facility 102. The one or more digital replica is used to classify each area of the plurality of areas of the digital facility 102 into the plurality of control point levels, such that the plurality of control point levels helps to simplify the user interface and provide ease of use. The control point level 1 holds the plurality of areas as shown in FIG. 1, such as the plurality of rooms 104, garden area 106, waiting area 108, parking area 110, common area 112, and the restaurant 114. In addition, control point level 2 consist of each area of the plurality of areas as shown of FIG. 1 for the restaurant 114, such as kitchen area 114a, sitting area 114b, reception area 114c, drinking area 114d, and restroom area 114e. The control point level 3 holds the key area or control point for maintaining the quality of the digital facility 102 as shown in FIG. 1 for restroom area 114e, such as spray shower 116a, commode 116b, and paper dispenser 116c. Further, the control point level 3 hold the key area of restroom 114e, such as door 116d, mirror 116e, basin 116f, soap dispenser 116g, exhaust fan 116h, curtain 116i, window 116j, second curtain 116k, cupboard 116l, fan 116m and bulb 116n. The control point level 4 holds the details of the condition that may occur to the key area, for curtain it would be Soft Stains, Hard Stains, Worn out, and the like. The level 4 will be the lowest level of the plurality of control point levels

Further, the smart control system 204 allocates the plurality of smart devices 202 for the digital facility 102 based on a plurality of micro descriptors. The allocation of the plurality of smart devices 202 is done in order to collect data whenever there is change in the environment of the Internet of things. The allocation is done to identify each area of the digital facility 102 where the plurality of smart devices 202 needs to be installed. The plurality of smart devices 202 is allocated to collect and exchange information between the devices.

In an embodiment of the present disclosure, the plurality of micro-descriptors is used to specify the responsibility area of the digital facility 102 in order to maintain quality and gather information regarding the quality in real time. The plurality of micro-descriptors is described for lowest level of the plurality of control point levels. The plurality of the micro-descriptor is used to specify each region of the plurality of regions where an issue may be raised by the visitor or where there are chances of the issue being related to the quality of the digital facility 102. The plurality of micro-descriptors is pre-defined in the smart control system 204 and may be updated at any time. The plurality of micro-descriptors includes but may not be limited to bed crack, linen condition, mattress, bedsheet stain, pillow cover, blanket sturdiness, bulb light, television light, adaptor, television wire, curtain rod, and curtain.

In an embodiment of the present disclosure, the plurality of micro-descriptors includes but may not be limited to table cover, chair cover, door, water cooler, heater, chair cover, carpet, mirror, bathroom cabinet, laptop stand, iron stand. In another embodiment of the present disclosure, the plurality of micro-descriptors includes soap dispenser, coffee machine, sturdiness, cleanliness, linen condition, shower pressure, air freshener, exhaust, faucets, toilet paper, and the like. In yet another embodiment of the present disclosure, the plurality of micro-descriptors includes welcome drink, elevator, emergency light, fragrance, elevator, shafts, Wi-Fi signal, staff dress, and the like. In yet another embodiment of the present disclosure, the plurality of micro-descriptors includes CCTV working, walls, ambiance, buffet counter, hygiene, staff grooming, CCTV video quality, and the like. In yet another embodiment of the present disclosure, the plurality of micro-descriptors includes but may not be limited to mop, table dust, staff behavior, kettle, window pane, T.V wire, light switch, feedback tab, fire safety, smoke alarm. In yet another embodiment of the present disclosure, the plurality of micro-descriptors includes but may not be limited to a public washroom, flush, wall, noise, upholstery, cupboard cover, cupboard lock, fan stand, fan, and air conditioner.

Furthermore, the smart control system 204 collects the second set of data associated with the digital facility 102. The second set of data is collected from the plurality of smart devices in real time. The second set of data includes information regarding the quality of each region of the plurality of regions of the digital facility 102 in real time. The second set of data includes information provided by the plurality of sensor, the one or more quality examiner, the one or more mystery auditors, visitor reviews, and call center review. In an embodiment of the present disclosure, the information collected includes but may not be limited to social media feedback, survey, and feedback tab. The plurality of smart devices 202 is used to collect information in order to identify issues, check visitor satisfaction and maintain the quality of the digital facility 102. The information also includes feedback which may be given by the employee, visitor, any other person through the survey, feedback tab, feedback box, through the email and the like. The information collected helps to identify the satisfaction or dissatisfaction regarding a service or a product.

In another embodiment of the present disclosure, the visitor reviews is the review and rating provided by the visitor at the digital facility 102, on any social media platform, as a testimonial on the digital facility 102 website, and the like. The visitor reviews act as a basis for improvement of the quality of the digital facility 102. The visitor reviews are collected at the digital facility 102 by using the feedback tabs, survey and the like. In addition, the visitor reviews include but is not limited to review about the staff, reviews about defects, reviews about overall experience at the digital facility 102. Furthermore, the visitor reviews include, but is not limited to reviews about water pressure, reviews about table issue, reviews about staff dress, reviews about the reception, reviews about the event, and reviews about the food. Moreover, the visitor reviews include, but is not limited to reviews about ambiance, reviews about fragrance, reviews about drinking water, reviews about electricity, reviews about reviews about sound level, reviews about the elevator. Also, the visitor reviews include but is not limited to reviews about the gym, reviews about the garden, reviews about the air conditioner, and the like.

In another embodiment of the present disclosure, call center review is a review provided by the call center which is collected by calling or by emailing visitors to provide review and rating. In addition, call center review includes but may not be limited to review about the staff, reviews about defects, reviews about overall experience at the digital facility, and reviews about the gym. Furthermore, call center review includes but may not be limited to reviews about the air conditioner, reviews about water pressure, reviews about table issue, reviews about staff dress, and reviews about the reception. Moreover, call center review includes reviews about ambiance, reviews about fragrance, reviews about drinking water, reviews about electricity, and the like. Also, call center review includes but may not be limited to about reviews about sound level, reviews about the elevator, reviews about the garden, reviews about the event, and reviews about the food.

Moreover, the smart control system 204 deciphers the collected second set of data into one or more matrix. The deciphering being done to align the second set of data into structured information in real time. The deciphering is done in order to transform the information collected in the second set of data to useful information based on the requirement. The deciphering involves checking the data in order to transform it into one or more matrix. The one or more matrix includes but may not be limited to a facility-specific matrix of the digital facility 102, a workforce specific matrix of the one or more workforces associated with the digital facility 102.

In an embodiment of the present disclosure, the facility specific matrix comprises data related to the digital facility 102 which includes but may not be limited to the plurality of control points, and estimated time to resolve the issue. In addition, the facility specific matrix includes but may not be limited to issue related to the plurality of control points. The facility specific matrix specific contains details of each micro descriptor of the plurality of micro-descriptors in order to check the status of the digital facility 102.

In an embodiment of the present disclosure, the workforce specific matrix comprises data related to the one or more workforces of the digital facility 102. The workforce specific matrix includes but may not be limited to demographic information of the one or more workforces, number of task assigned to the one or more workforces, and the like. The one or more workforces for the workforce specific matrix is the one or more quality examiners, and the like. In addition, the workforce specific matrix includes but may not be limited to a percentage of task completion by the one or more workforces, number of issues not caught by the one or more workforces, and incentives awarded to the one or more workforces, and the like.

In an embodiment of the present disclosure, the task is the activity which needs to be performed by the one or more workforces associated with the digital facility 102. The one or more workforces include one or more quality examiner and the like. The task assigned to the one or more workforces include but is not limited to, auditing rooms, quality checking, checking parking area, and checking staff dress. In another embodiment of the present disclosure, the task assigned to the one or more workforces includes but may not be limited to checking the placement of things, checking the quality of food, and checking the interior.

In an embodiment of the present disclosure, the task completion by the one or more workforce is associated with the total number of the task assigned to the one or more workforce. Further, the task completion is associated with the total number of the task completed by the one or more workforce associated with the digital facility 102. The task completion is defined for the one or more quality examiners of the one or more workforces. The task completion defines the performance of the one or more workforces associated with the digital facility 102.

In an embodiment of the present disclosure, the issues not caught by the one or more workforces are associated with the one or more issues which is not identified by the one or more quality examiner during the audit. The issue not caught is those which are reported by the visitor of the digital facility 102. The number of issues not caught affects the performance of the one or more quality examiner based on which incentives are decided.

In an embodiment of the present disclosure, the incentives are awarded to the one or more workforces associated with the digital facility 102. Incentives are awarded based on the performance of the one or more workforces associated with the digital facility 102. The incentives are awarded for a specified period of time. The specified period of time includes weekly performance, monthly performance, quarterly performance, yearly performance, daily incentives and the like. The incentives are awarded based on a plurality of factors. The plurality of factors includes but may not be limited to percentage of task completion, the number of issues not caught, visitor reviews, number of high severity issue, number of reoccurrence of the one or more issues and the like.

In an example, the incentives are awarded to the one or more quality examiners of the one or more workforces associated with the digital facility 102 based on the percentage of task completion and the number of issue not caught of the plurality of factors. The incentives are awarded to the one or more staff based on the number of high severity issue, visitor reviews, and number of reoccurrence of the one or more issues of the plurality of factors.

Also, the smart control system 204 analyzes the facility specific matrix with a pre-defined standard quality matrix in real time. The analysis is done to identify one or more issues that may occur within the digital facility 102. The pre-defined standard quality matrix includes but may not be limited to the quality of standards that need to be kept in order to maintain the quality of the digital facility 102 to meet visitor satisfaction.

Also, the smart control system 204 assigns a degree of severity to the identified one or more issues. The degree of severity is assigned to recognize the one or more issues comprising a high degree of severity. In an embodiment of the present disclosure, the degree of severity is the number of values assigned to specify the quality standard of the one or more issues. The high degree of severity means the one or more issues is reaching the time to resolve and the one or more issues have not been resolved. The high degree of severity is assigned to that one or more issues which is having a critical problem and requires being resolved at the earliest. The low level of severity is assigned to one or more issues which are not critical.

In an example, based on the deviation the one or more issues identified are cracked wall X having time to resolve as 5 days, broken window pane Y having time to resolve as 2-day, broken pipe Z having to resolve as ½ day. The smart control system 204, assign the degree of severity to the above one or more issues as broken pipe Z having a high degree of severity, window pane Y having a medium degree of severity, and low degree of severity to the cracked wall X.

Also, the smart control system 204 apprises the one or more workforces associated with the digital facility 102 to resolve the one or more issues comprising the high degree of severity and the plurality of smart devices 202 to take action. The apprising is done in order to rectify the identified the one or more issues. The rectification is done to maintain the quality of the digital facility 102. The smart control system 204 apprises the one or more workforces in real time by informing about the severity of the one or more issues and the estimated time to resolve the one or more issues. The information is sent to the one or more quality examiner, the one or more mystery auditors of the one or more workforces. The apprising is done to the one or more workforces by sending notification to the one or more portable communication device connected in the network of Internet of things. The apprising is done by sending details to the plurality of smart devices 202 to take action based on the analysis of the environment.

In an embodiment of the present disclosure, the smart control system 204 ceases the booking of the plurality of regions of the digital facility 102. The smart control system 204 checks the compliance ratio of the digital facility 102 in real time. If the compliance ratio shows high number of issues open at the region of the plurality of regions of the digital facility 102 with high degree of severity than the identified region is prevented from booking. The ceasing is done in real time and each region of the plurality of regions is ceased from booking until the degree of severity is reduced to meet the quality standard of the digital facility 102.

The compliance ratio is a metrics which defines the number of issues which are open for resolution and the severity of each issue for each region of the plurality of regions of the digital facility 102. The compliance ratio is being updated in real time based on the number of issue being identified and issue which has been resolved.

In another embodiment of the present disclosure, the smart control system 204 forecasts the occurrence of the one or more issues and the estimated time to resolve the one or more issues in order to maintain quality of the digital facility 102. The prevention is done in real time using machine learning algorithm wherein, forecasting is done by analyzing the previously stored data and the time-series data received in real time to identify the one or more issues. The one or more issues that has been forecasted by the smart control system 204 is sent as notification to the one or more workforces associated with the digital facility 102 in order to rectify the one or more issues before the estimated time.

In yet another embodiment of the present disclosure, the smart control system 204 awarding incentive to the one or more workforces associated with the digital facility 102. Incentives are awarded based on the performance of the one or more workforces associated with the digital facility 102 wherein, the incentive is decided for a specified period of time. The incentive is awarded based on the analysis of the workforce specific matrix. The incentive is awarded based on the number of task completion, the number of issues not caught, the rating given by the visitor, and the like. The incentive is awarded by doing analysis of the workforce specific matrix. The incentive is awarded to those having high number of task completion rate with low number off issue not caught and high rating given by the visitor and, the like.

The smart control system 204 is associated with the server 208 through the communication network 206. In an embodiment of the present disclosure, the communication network 206 enables the smart control system 204 to gain access to the internet for transmitting data to the server 208. Moreover, the communication network 206 provides a medium to transfer the data between the smart control system 204 and the server 208. Further, the medium for communication may be infrared, microwave, radio frequency (RF) and the like.

In an embodiment of the present disclosure, the smart control system 204 is located in the server 208. In another embodiment of the present disclosure, the smart control system 204 is located in the one or more portable communication device. The server 208 handles each operation and task performed by the smart control system 204. The server 208 stores one or more instructions for performing the various operations of the smart control system 204.

In another embodiment of the present disclosure, the server 208 is a cloud server which is built, hosted and delivered through a cloud computing platform. The cloud computing is the process of using remote network server which are hosted on the internet to store, manage, and process data. The use of cloud server helps to access the smart control system 204 to be accessed from anywhere using the internet.

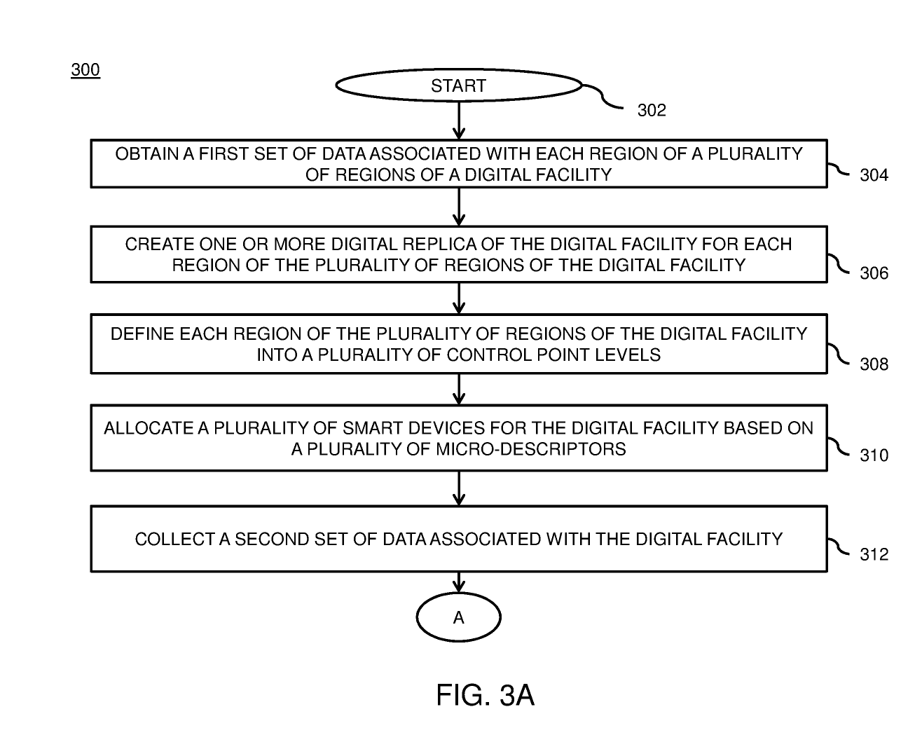

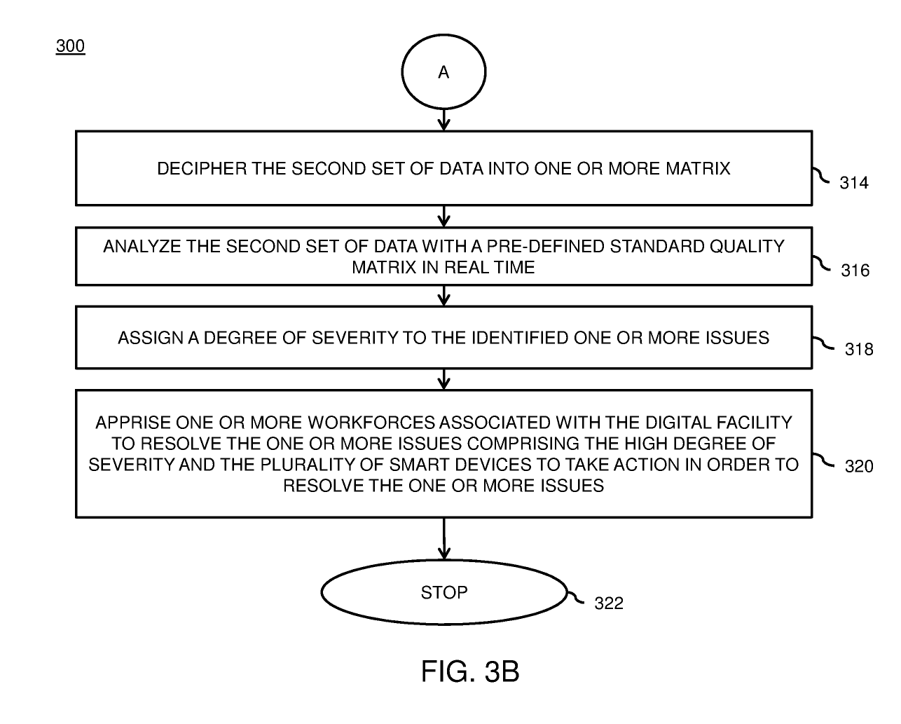

FIG. 3A and FIG. 3B illustrate a flowchart 300 for a method for quality control of the digital facility 102 based on the internet of things, in accordance with various embodiments of the present disclosure. It may be noted that to explain the process steps of the flowchart 300, references will be made to the system elements of FIG. 1 and FIG. 2. It may be noted that the flowchart 300 may have lesser or more number of steps.

The flowchart 300 initiates at step 302. Following step 302, at step 304, the smart control system 204 obtains the first set of data associated with each region of the plurality of regions of the digital facility 102. The first set of data is received from the plurality of architectural sources. At step 306, the smart control system 204 creates the one or more digital replica for each region of the plurality of regions of the digital facility 102 by using the first set of data in real time. At step 308, the smart control system 204 defines each region of the plurality of regions of the digital facility 102 into the plurality of control point levels. The plurality of control point levels is used to simplify the distribution of each area of the plurality of areas of the digital facility 102. At step 310, the smart control system 204 allocates the plurality of smart devices 202 for the digital facility 102 based on a plurality of micro descriptors. The allocation of the plurality of smart devices 202 is done in order to collect data whenever there is change in the environment of the Internet of things. At step 312, the smart control system 204 collects the second set of data associated with the digital facility 102. The second set of data is collected from the plurality of smart devices in real time. The second set of data includes information regarding the quality of each region of the plurality of regions of the digital facility 102 in real time. At step 314, the smart control system 204 deciphers the collected second set of data into the one or more matrix. The deciphering is done to align the second set of data into the structured information in real time. The deciphering is done in order to transform the information collected in the second set of data to useful information based on the requirement. At step 316, the smart control system 204 analyzes the facility specific matrix with the pre-defined standard quality matrix in real time. The analysis is done to identify the one or more issues that may occur within the digital facility 102. At step 318, the smart control system 204 assigns a degree of severity to the identified one or more issues. The degree of severity is assigned to recognize the one or more issues comprising a high degree of severity. At step 320, the smart control system 204 apprises the one or more workforces associated with the digital facility 102 to resolve the one or more issues comprising the high degree of severity and the plurality of smart devices 202 to take action. The apprising is done in order to rectify the identified the one or more issues. The rectification is done to maintain the quality of the digital facility 102. The flow chart 300 terminates at step 322.

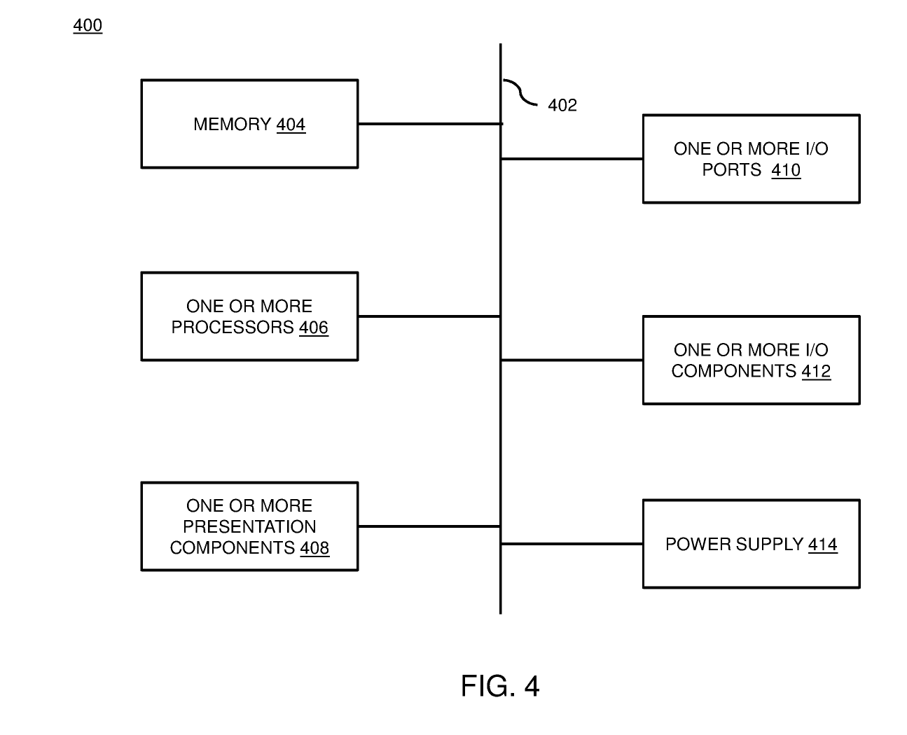

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 4 is merely illustrative of an exemplary computing device 400 may be used in connection with one or more embodiments of the present disclosure. Distinction is not made between such categories as workstation, server, laptop, hand-held device and the like, as all are contemplated within the scope of FIG. 4 and reference to “the computing device 400.”

The computing device 400 typically includes a computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 404 includes the computer-storage media in the form of volatile and/or nonvolatile memory. The memory 404 may be removable, non-removable, or a combination thereof. Exemplary hardware devices include solid-state memory, hard drives, optical-disc drives and the like. The computing device 400 includes the one or more processors to read data from various entities such as memory 404 or I/O components 412. The one or more presentation components 408 present data indications to a user or other device. Exemplary presentation components include a display device, speaker, printing component, vibrating component and the like. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device and the like.

What is claimed is:

1. A computer-implemented method for quality control of a digital facility based on internet of things, the computer-implemented method comprising:
obtaining, at a smart control system with a processor, a first set of data associated with each region of a plurality of regions of the digital facility, wherein the first set of data being obtained from a plurality of architectural sources in real time;
creating, at the smart control system with the processor, one or more digital replica of the digital facility for each region of the plurality of regions of the digital facility, wherein the one or more digital replica being created with the facilitation of the first set of data;
defining, at the smart control system with the processor, each region of the plurality of regions of the digital facility into a plurality of control point levels, wherein the plurality of control point levels being classified based on a pre-defined set of data associated with the one or more digital replica;
allocating, at the smart control system with the processor, a plurality of smart devices for the digital facility based on a plurality of micro-descriptors, wherein the plurality of micro-descriptors is described for lowest level of the plurality of control point levels, wherein the plurality of smart devices being internet of things enabled devices;
collecting, at the smart control system with the processor, a second set of data associated with the digital facility, wherein the second set of data being collected from the plurality of smart devices in real time;
deciphering, at the smart control system with the processor, the second set of data into one or more matrix, wherein deciphering being done to align the second set of data into a structured information, wherein the deciphering being done in real time;
analyzing, at the smart control system with the processor, the second set of data with a pre-defined standard quality matrix in real time, wherein analyzing being done to identify one or more issues associated with the digital facility;
assigning, at the smart control system with the processor, a degree of severity to the identified one or more issues, wherein the degree of severity being assigned to recognize the one or more issues comprising a high degree of severity; and
apprising, at the smart control system with the processor, one or more workforces associated with the digital facility to resolve the one or more issues comprising the high degree of severity and the plurality of smart devices to take action in order to resolve the one or more issues.

2. The computer-implemented method as recited in claim 1, wherein the plurality of architectural sources comprises image capturing devices, a digital blueprint, a portable communication device, and one or more geographical sensors.

3. The computer-implemented method as recited in claim 1, wherein the plurality of smart devices comprises a plurality of sensors, actuator and one or more portable communication devices, wherein the plurality of smart devices being connected to each other through internet.

4. The computer-implemented method as recited in claim 1, wherein the one or more matrix comprises a facility specific matrix, a workforce specific matrix, wherein the one or more matrix being deciphered in real time.

5. The computer-implemented method as recited in claim 1, wherein the one or more issues comprises a broken door, faucet flow, defected bulb, defected fire alarm, low intensity of bulb, unclean floor, high volume of noise, putrid odor, broken cabinet, blocked shower, Wi-Fi connection.

6. The computer-implemented method as recited in claim 1, further comprising updating, at the smart control system with the processor, the first set of data, the second set of data, the one or more issues and the degree of severity, wherein the updating being done in real time.

7. The computer-implemented method as recited in claim 1, further comprising storing, at the smart control system with the processor, the first set of data, the second set of data, the one or more issues and the degree of severity, wherein the storing being done in real time.

8. The computer-implemented method as recited in claim 1, further comprising ceasing, at the smart control system with the processor, booking of each region of the plurality of regions of the digital facility, wherein the ceasing being done based on the high degree of severity, accordance ratio of the digital facility, wherein the ceasing being done in real time.

9. The computer-implemented method as recited in claim 1, further comprising forecasting, at the smart control system with the processor, the one or more issues and estimated time to resolve the one or more issues in order to maintain a quality of the digital facility, wherein the forecasting being done by analyzing already stored data and time-series data in real time.

10. The computer-implemented method as recited in claim 1, further comprising awarding, at the smart control system with the processor, incentives to the one or more workforces associated with the digital facility based on a plurality of factors.

11. A computer system comprising:
one or more processor; and
a memory coupled to the one or more processors, the memory for storing instructions which, when executed by the one or more processors, cause the one or more processors to perform a method for quality control of a digital facility based on internet of things, the method comprising:
obtaining, at a smart control system, a first set of data associated with each region of a plurality of regions of the digital facility, wherein the first set of data being obtained from a plurality of architectural sources in real time;
creating, at the smart control system, one or more digital replica of the digital facility for each region of the plurality of regions of the digital facility, wherein the one or more digital replica being created with the facilitation of the first set of data;
defining, at the smart control system, each region of the plurality of regions of the digital facility into a plurality of control point levels, wherein the plurality of control point levels being classified based on a pre-defined set of data associated with the one or more digital replica;
allocating, at the smart control system, a plurality of smart devices for the digital facility based on a plurality of micro-descriptors, wherein the plurality of micro-descriptors is described for lowest level of the plurality of control point levels, wherein the plurality of smart devices being internet of things enabled devices;
collecting, at the smart control system, a second set of data associated with the digital facility, wherein the second set of data being collected from the plurality of smart devices in real time;
deciphering, at the smart control system, the second set of data into one or more matrix, wherein deciphering being done to align the second set of data into a structured information, wherein the deciphering being done in real time;
analyzing, at the smart control system, the second set of data with a pre-defined standard quality matrix in real time, wherein analyzing being done to identify one or more issues associated with the digital facility;
assigning, at the smart control system, a degree of severity to the identified one or more issues, wherein the degree of severity being assigned to recognize the one or more issues comprising a high degree of severity; and
apprising, at the smart control system, one or more workforces associated with the digital facility to resolve the one or more issues comprising the high degree of severity and the plurality of smart devices to take action in order to resolve the one or more issues.

12. The computer system as recited in claim 11, wherein the plurality of architectural sources comprises image capturing devices, a digital blueprint, a portable communication device, and one or more geographical sensors.

13. The computer system as recited in claim 11, wherein the plurality of smart devices comprises a plurality of sensors, actuator and one or more portable communication devices, wherein the plurality of smart devices being connected to each other through internet.

14. The computer system as recited in claim 11, wherein the one or more matrix comprises a facility specific matrix, a workforce specific matrix, wherein the one or more matrix being deciphered in real time.

15. The computer system as recited in claim 11, wherein the one or more issues comprises a broken door, faucet flow, defected bulb, defected fire alarm, low intensity of bulb, unclean floor, high volume of noise, putrid odor, broken cabinet, blocked shower, Wi-Fi connection.

16. The computer system as recited in claim 11, further comprising storing, at the smart control system, the first set of data, the second set of data, the one or more issues and the degree of severity, wherein the storing being done in real time.

17. The computer system as recited in claim 11, further comprising ceasing, at the smart control system, booking of each region of the plurality of regions of the digital facility, wherein the ceasing being done based on the high degree of severity, accordance ratio of the digital facility, wherein the ceasing being done in real time.

18. The computer system as recited in claim 11, further comprising forecasting, at the smart control system, the one or more issues and estimated time to resolve the one or more issues in order to maintain a quality of the digital facility, wherein the forecasting being done by analyzing already stored data and time-series data in real time.

19. The computer system method as recited in claim 11, further comprising awarding, at the smart control system, incentives to the one or more workforces associated with the digital facility based on a plurality of factors.

20. A computer-readable storage medium encoding computer executable instructions that, when executed by at least one processor, performs a method for quality control of a digital facility based on internet of things, the method comprising:
obtaining, at a computing device, a first set of data associated with each region of a plurality of regions of the digital facility, wherein the first set of data being obtained from a plurality of architectural sources in real time;
creating, at the computing device, one or more digital replica of the digital facility for each region of the plurality of regions of the digital facility, wherein the one or more digital replica being created with the facilitation of the first set of data;
defining, at the computing device, each region of the plurality of regions of the digital facility into a plurality of control point levels, wherein the plurality of control point levels being classified based on a pre-defined set of data associated with the one or more digital replica;
allocating, at the computing device, a plurality of smart devices for the digital facility based on a plurality of micro-descriptors, wherein the plurality of micro-descriptors is described for lowest level of the plurality of control point levels, wherein the plurality of smart devices being internet of things enabled devices;
collecting, at the computing device, a second set of data associated with the digital facility, wherein the second set of data being collected from the plurality of smart devices in real time;
deciphering, at the computing device, the second set of data into one or more matrix, wherein deciphering being done to align the second set of data into a structured information, wherein the deciphering being done in real time;
analyzing, at the computing device, the second set of data with a pre-defined standard quality matrix in real time, wherein analyzing being done to identify one or more issues associated with the digital facility;
assigning, at the computing device, a degree of severity to the identified one or more issues, wherein the degree of severity being assigned to recognize the one or more issues comprising a high degree of severity; and
apprising, at the computing device, one or more workforces associated with the digital facility to resolve the one or more issues comprising the high degree of severity and the plurality of smart devices to take action in order to resolve the one or more issues.
